(19) United States
(12) Patent Application Publication
(10) Pub. No.: US 2012/0188871 A1
(43) Pub. Date: Jul. 26, 2012

(54) ETHERNET PORT SPEED CONTROL METHOD AND DEVICE

(76) Inventors: Jun Liu, Shanghai (CN); Christophe Wolff, Benfeld (FR)

(21) Appl. No.: 13/499,592

(22) PCT Filed: Dec. 20, 2010
(86) PCT No.: PCT/CN2010/002092

§ 371 Date: Mar. 30, 2012

(30) Foreign Application Priority Data
Dec. 21, 2009 (CN) 200910260884

(51) Int. Cl. H04L 12/24

(52) U.S. Cl. 370/230

(57) ABSTRACT

There is proposed a speed control method for controlling a link speed of an Ethernet port. The method comprises steps of detecting the amount of data to be sent via the Ethernet port, and controlling the link speed of the Ethernet port based on the detected amount of data. The step of controlling the link speed of the Ethernet port based on the detected amount of data further comprises steps of comparing the detected amount of data with a predefined threshold, and setting the link speed level of the Ethernet port based on the comparison. According to the solutions provided in the embodiments of the present invention, the present invention may set the Ethernet port to a lower speed when there is no large amount of data to be sent, and thus implements power saving without changes to the infrastructure of the Ethernet.

### FIELD OF THE INVENTION

The implementations of the present invention generally relate to local area network techniques and, more particularly, to a method and device for controlling speed of an Ethernet port.

### BACKGROUND OF THE INVENTION

Ethernet is a most popular local area networking technique in current applications. Nowadays, it replaces the other local area networks, such as Token Ring, FDDI and ARCNET, to a great extent. The 100M Ethernet has developed at a great pace since the end of last century, and gigabit Ethernet or even 10 Gigabit Ethernet appear and are widely used all over the world under the introduction by International Organizations and leading companies.

Greenhouse effect are now attracting more and more attentions. Saving power and reducing the carbon dioxide release to earth atmosphere are very challenging jobs for human being around the world. To do that, green IT is required for all new communication and office devices, including Ethernet. It becomes more and more critical in Ethernet system and product design. At the same time, communications are desired to be faster and faster. High data rate definitely needs more power, which conflicts with the power saving concept. Accordingly, there is a problem to be solved immediately to trade off between high speed communication and power saving in Ethernet.

In general, there are three solutions for this problem. The first one is to use low consumption ICs in product design. The second one is to provide each function block with one independently controlled power supply. The power supply is cut off when the respective function block is disabled. These two solutions need expensive special chips to improve the architecture of the system which will result in high cost. Furthermore, the usage of such chips has the risk of out of stock at the chip supplier due to low sales volume. The third one is to use lowed clock speed when the function is in idle status. Though the third one does not need to update the architecture of the system, lowering clock speed will surely affect the whole performance of the system. Moreover, the energy saved totally is limited and it is difficult to estimate how much energy has been saved. And, lowering clock speed introduces complexity in the actual software development. Therefore, there is a need for a power saving solution that is easy to implement and cost little.

On the other hand, current most Ethernet devices needn't operate in full speed state all the time, for example, PCs and IP phones. When there is no a large amount of data to be sent, the Ethernet port can be set to a low speed so as to save power. In our current NOE IP phone, one Gigabit Ethernet port will cost 390 mW power more than Fast Ethernet port.

The Ethernet port that is used in current applications has a fixed link speed.

Therefore, one solution is needed which controls the speed of the Ethernet ports according to the actual scenario of the Ethernet.

### SUMMARY OF THE INVENTION

To this end, a speed control method and device for Ethernet port is provided.

According to an aspect of the present invention, a speed control method is provided for controlling a link speed of a first Ethernet port. The method comprises steps of detecting the amount of data to be sent via the first Ethernet port, and controlling the link speed of the first Ethernet port based on the detected amount of data.

Preferably, controlling the link speed of the first Ethernet port based on the detected amount of data further comprises steps of comparing the detected amount of data with a predefined threshold, and setting the link speed level of the first Ethernet port based on the comparison.

Preferably, the predefined threshold comprises a plurality of different predefined thresholds, and the link speed level comprises a plurality of different link speed levels.

Preferably, when the predefined threshold comprises a first predefined threshold and a second predefined threshold, the first predefined threshold being lower than the second predefined threshold, and the link speed level comprises a first link speed level, a second link speed level and a third link speed level, link speeds corresponding to the first, second and third link speed levels increasing one by one, setting the link speed level of the first Ethernet port based on the comparison comprises steps of using the first link speed level for the first Ethernet port if the detected amount of data is not larger than the first predefined threshold, using the second link speed level for the first Ethernet port if the detected amount of data is larger than the first predefined threshold and lower than the second predefined threshold, and using the third link speed level for the first Ethernet port if the detected amount of data is not lower than the second predefined threshold.

Preferably, data link speed of a second Ethernet port connected to the first Ethernet port adaptively varies as the data link speed of the first Ethernet port changes.

According to another aspect of the present invention, a speed control device is provided for controlling a link speed of a first Ethernet port. The speed control device comprises a detection unit for detecting the amount of data to be sent via the first Ethernet port, and a control unit for controlling the link speed of the first Ethernet port based on the detected amount of data.

Preferably, the control unit comprises a comparison unit for comparing the detected amount of data with a predefined threshold, and a setting unit for setting the link speed level of the first Ethernet port based on the comparison.

Preferably, the first Ethernet port is included in the speed control device.

According to the solutions as above, the present invention may set the Ethernet port to a lower speed when there is no large amount of data to be sent, and thus implements power saving without changes to the infrastructure of the Ethernet.

### BRIEF DESCRIPTION OF THE DRAWINGS

The above and other objects, features and advantages of the present invention will be clearer from the following detailed description about the preferred embodiments of the present invention taken in conjunction with the accompanied drawings, in which:

FIG. 1 shows a topology of an Ethernet according to an embodiment of the present invention;

FIG. 2 shows a diagram block of an IP phone according to an embodiment of the present invention; and

FIG. 3 shows a flow chat of a method for an IP phone controlling a link speed of its Ethernet port according to an embodiment of the present invention.

### DETAILED DESCRIPTION OF THE PREFERRED EMBODIMENTS

The present invention will be now described according to its preferred embodiments by referring to the Figures of the enclosed drawings. The detailed and functions that are not essential to the present invention are omitted so as to not obscure understanding of the present invention.

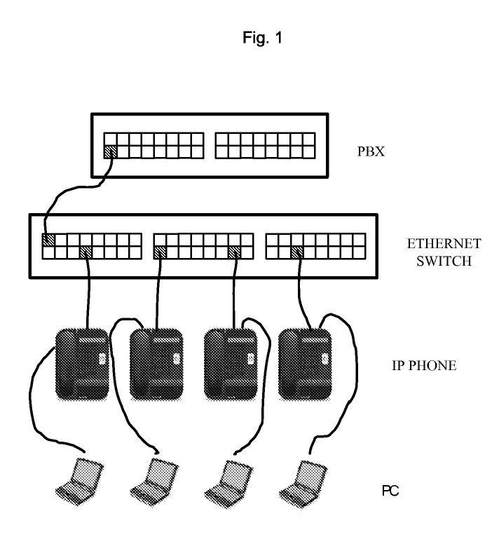

FIG. 1 shows a topology of an Ethernet according to an embodiment of the present invention, including a Private Branch Exchange (PBX), an Ethernet switch, a plurality of IP phones, and a plurality of Personal Computers (PCs). What shall be noted is that two types of terminals, i.e., IP phones and PCs, are shown in FIG. 1. It can be recognized by those skilled in the art that the present invention is applicable in other cases where there is only one type of terminal (i.e., only the IP phones or the PCs exist) or there are many types of terminals. Additionally, what shall be noted is that a plurality of IP phones and a plurality of PCs are shown in FIG. 1. It can be recognized by those skilled in the art that the present invention is applicable in other cases where there exist only one IP phone and one PC.

As shown in FIG. 1, there are six Ethernet ports, one on the PBX, two on the Ethernet switch directed to the PBX and the IP phone respectively, two on the IP phone directed to the Ethernet switch and the PC respectively, and the last one on the PC. If all the six Ethernet ports are set to Fast mode from Gigabit mode, power of 390 mW*6=2340 mW will be saved totally.

However, lowering the link speed of Ethernet port at the switch may introduce higher development cost in real applications, and may affect performance of other operation while not necessarily resulting in power saving. Meanwhile, lowering the link speed of Ethernet port at the terminal facilitates simplicity of program design of the system. In view of this, the present invention aims at lowering the link speed of Ethernet port at the terminal (i.e., the IP phone or the PC).

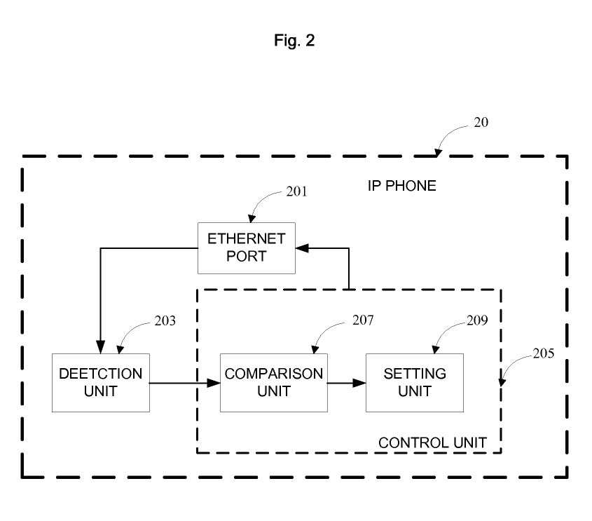

FIG. 2 shows a diagram block of an IP phone according to an embodiment of the present invention, which is applicable in the Ethernet as shown in FIG. 1.

As shown in FIG. 2, the IP phone 20 comprises an Ethernet port 201, a detection unit 203 and a control unit 205. The Ethernet port 201 communicates with an Ethernet switch or other terminals. The detection unit 203 detects the amount of data to be sent via the Ethernet port 201. The control unit 205 controls the link speed of the Ethernet port 201 based on the amount of data detected by the detection unit 203. In particular, the control unit 205 comprises a comparison unit 207 and a setting unit 209. The comparison unit 207 compares the amount of data detected by the detection unit 203 with a predefined threshold. Here, the predefined threshold may be a default value set in advance, or set in real-time by the user according to actual communication conditions. The setting unit 209 sets the link speed of the Ethernet port 201 according to the comparison results of the comparison unit 207.

What shall be noted is that FIG. 2 only shows the diagram block of an IP phone. It may be recognized by those skilled in the art that the diagram block as shown in FIG. 2 may be also applied to other terminals such as PC. In other words, the diagram block as shown in FIG. 2 is applicable to the IP phones and PCs in the scenario shown in FIG. 1 and other terminals.

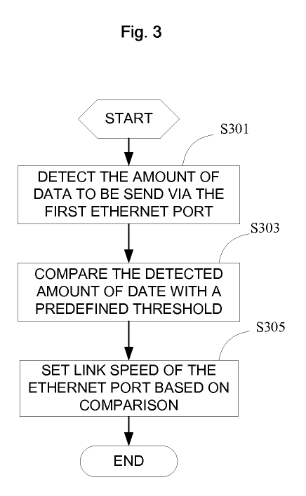

FIG. 3 shows a flow chat of a method for the IP phone 20 as shown in FIG. 2 controlling a link speed of its own Ethernet port. The steps of FIG. 3 are described in detailed in conjunction with FIG. 2.

Firstly, the detection unit 203 detects the amount of data to be sent via the Ethernet port 201 by the IP phone 20 at step S301.

In the next, the comparison unit 207 compares the amount of data detected at step S301 with a predefined threshold at step S303. What shall be noted is, the predefined threshold here may be a default value set in advance in the system, or set in real-time by the user according to actual communication conditions.

What shall be further explained is that the predefined threshold here may includes just one or several, this dependents on link speed modes that the Ethernet port is capable of supporting. For example, with regard to an Ethernet port that can support 10/100/1000 Mbps link speeds, two different predefined thresholds A1 and A2 are needed. In such a case, the comparison unit 207 compares the amount of data detected by the detection unit 203 with the thresholds A1 and A2, respectively.

Next, at step S305, the setting unit 209 sets the link speed of the Ethernet port 201 based on the comparison result obtained at step S305.

Still take the above Ethernet port that can support 10/100/1000 Mbps link speeds as an example. Assume A1 is lower than A2. The setting unit 209 sets the link speed of the Ethernet port 201 to 10 Mbps if the detected amount of data is not larger than A1. The setting unit 209 sets the link speed of the Ethernet port 201 to 100 Mbps if the detected amount of data is larger than A1 while lower than A2. The setting unit 209 sets the link speed of the Ethernet port 201 to 1000 Mbps if the detected amount of data is not lower than A2.

Nowadays, most Ethernet devices in market are capable of adaptively adjusting their own link speeds according to the link speeds of a device to which they are connected. Here, still take the above Ethernet port that can support 10/100/1000 Mbps link speeds as an example. Such an Ethernet port can adaptively adjust its own link speeds as shown in table 1 below:

TABLE 1

| Link speed of a | Adjusted Link speed of a Local |
|---|---|
| Remote Device | Ethernet Port |
| 10 Mbps | 10 Mbps |
| 100 Mbps | 100 Mbps |
| 1000 Mbps | 1000 Mbps |

In view of this, on the basis of the Ethernet port speed control solution according to the embodiments of the present invention, the present invention controls the link speed of a local Ethernet port based on the amount of data to be sent via the local Ethernet port, and a link speed of a remote Ethernet port connected to the local Ethernet port is adaptively adjusted, thereby at least power consumed in two Ethernet ports can be saved.

In the topology as shown in FIG. 1, if the IP phone 20 of FIG. 2 sets a link speed of the Ethernet port based on the amount of data to be sent via the Ethernet port 201, the Ethernet port of the Ethernet switch or that of the PC that are connected to the IP phone will have their link speeds adjusted to be consistent with the link speed of the Ethernet port 201.

In this way, the IP phone appropriately decreases the link speeds of two Ethernet ports when the amount of data to be sent via the Ethernet port 201 is low. Accordingly, two Ethernet ports that are connected to these two Ethernet ports (i.e., the Ethernet port on the PC and that on the Ethernet switch directed to the IP phone) adaptively decrease their link speeds. Therefore, power on four Ethernet ports can be saved without changes to the infrastructure of the Ethernet.

Here, we use an NOE EE terminal to calculate how much energy can be saved. Usually, the effective communication time of each terminal will not be more than 8 hours each day, so it can be set to low link speed for 16 hours. One terminal can save energy of 16 h*0.78W=0.01248 KWh one day; in one year, it can save energy of 0.01248*365=4.5552 KWh. If ALU sells 500,000 EE units, it can help save energy of 4.5552*500,000=2277.6K KWh, corresponding to 911.04 tons of standard coal (0.4 kg standard coal corresponds to 1 KWh electrical power).

What shall be noted is that the present invention also may control the link speeds of the Ethernet ports at the terminals (such as IP phones and PCs) in the Ethernet switch shown in FIG. 1. A program for an Ethernet switch can be implemented which can force the Ethernet port to operate at a certain speed by setting the PHY register in the similar manner as the terminal. The detailed description is omitted for simplicity.

The above description and figures only illustrate the principle of the present invention. It can be recognized that different structures can be proposed by those skilled in the art though these structures are not explicitly described or shown here, which embody the principle of the present invention and thus shall be included within the spirit and scope of the present invention. Furthermore, all the examples mentioned here are only for the purpose of teaching to assist the reader to understand the principle of the present invention and the contribution of the inventor, and shall in no way be considered as limitation to the special examples and conditions. Moreover, the statement and its special example of the principle, aspect and embodiments of the present invention shall comprise the equivalents thereof.

Although the embodiments of the present invention have been described herein with reference to the above description, it is to be understood by those skilled in the art that various modifications or local substitutions within the scope of the present invention fall into the scope defined by the attached claims. Therefore, the present invention should only be defined by the claims.

What is claimed is:

1. A speed control method for controlling a link speed of a first Ethernet port, comprising steps of:
detecting the amount of data to be sent via the first Ethernet port, and
controlling the link speed of the first Ethernet port based on the detected amount of data.

2. The method according to claim 1, wherein controlling the link speed of the first Ethernet port based on the detected amount of data further comprises steps of:
comparing the detected amount of data with a predefined threshold, and
setting the link speed level of the first Ethernet port based on the comparison.

3. The method according to claim 2, wherein the predefined threshold comprises a plurality of different predefined thresholds and the link speed level comprises a plurality of different link speed levels.

4. The method according to claim 2, wherein the predefined threshold comprises a first predefined threshold and a second predefined threshold, the first predefined threshold being lower than the second predefined threshold, and wherein the link speed level comprises a first link speed level, a second link speed level and a third link speed level, link speeds corresponding to the first, second and third link speed levels increasing one by one.

5. The method according to claim 4, wherein setting the link speed level of the first Ethernet port based on the comparison comprises steps of:
using the first link speed level for the first Ethernet port if the detected amount of data is not larger than the first predefined threshold,
using the second link speed level for the first Ethernet port if the detected amount of data is larger than the first predefined threshold and lower than the second predefined threshold, and
using the third link speed level for the first Ethernet port if the detected amount of data is not lower than the second predefined threshold.

6. The method according to claim 1, wherein data link speed of a second Ethernet port connected to the first Ethernet port adaptively varies as the data link speed of the first Ethernet port changes.

7. A speed control device for controlling a link speed of a first Ethernet port, comprising:
a detection unit for detecting the amount of data to be sent via the first Ethernet port, and
a control unit for controlling the link speed of the first Ethernet port based on the detected amount of data.

8. The device according to claim 7, wherein the control unit comprises:
a comparison unit for comparing the detected amount of data with a predefined threshold, and
a setting unit for setting the link speed level of the first Ethernet port based on the comparison.

9. The device according to claim 8, wherein the predefined threshold comprises a plurality of different predefined thresholds and the link speed level comprises a plurality of different link speed levels.

10. The device according to claim 8, wherein the predefined threshold comprises a first predefined threshold and a second predefined threshold, the first predefined threshold being lower than the second predefined threshold, and wherein the link speed level comprises a first link speed level, a second link speed level and a third link speed level, link speeds corresponding to the first, second and third link speed levels increasing one by one.

11. The device according to claim 10, wherein the setting unit is configured to:
use the first link speed level for the first Ethernet port if the detected amount of data is not larger than the first predefined threshold,
use the second link speed level for the first Ethernet port if the detected amount of data is larger than the first predefined threshold and lower than the second predefined threshold, and
use the third link speed level for the first Ethernet port if the detected amount of data is not lower than the second predefined threshold.

12. The device according to claim 7, wherein data link speed of a second Ethernet port connected to the first Ethernet port adaptively varies as the data link speed of the first Ethernet port changes.

13. The device according to claim 7, wherein the first Ethernet port is included in the device.
